(19) United States
(12) Patent Application Publication
(10) Pub. No.: US 2016/0035167 A1
(43) Pub. Date: Feb. 4, 2016

(54) Circular-Track Ball-Drawing Device

(71) Applicant: Tzu-Hsiang Tseng, Taichung City (TW)

(72) Inventor: Tzu-Hsiang Tseng, Taichung City (TW)

(21) Appl. No.: 14/449,149

(22) Filed: Aug. 1, 2014

(51) Int. Cl. G07C 15/00; A63F 11/00

(52) U.S. Cl. CPC G07C 15/001; A63F 11/0011

(57) ABSTRACT

A circular-track ball-drawing device includes a circular ball-delivering mechanism and a transmission assembly. The circular ball-delivering mechanism has transparent upper and lower semicircular housings, curved joining pieces positioning a ball-retaining bar, and a helm-like wheel housed by the semicircular housings. The transmission assembly includes a support, a motor and a driving shaft. The upper and lower semicircular housings are such joined by the curved joining pieces that upper and lower openings are foamed. A combination of the upper and lower semicircular housings such assembled is fixed to the support. The helm-like wheel is driven by the motor through the driving shaft. Thereby, lottery balls are taken into the circular ball-delivering mechanism through the lower opening and discharged at the upper opening, and the whole process is visible from outside.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to lottery-drawing machines, and more particularly to a circular-track ball-drawing device, which provides lottery-drawing spectators with visibility throughout a process where lottery balls in the device are mixed and drawn by random.

2. Description of Related Arts

The conventional lottery-ball drawing machines typically use a blower to blow and thereby mix lottery balls in a mixing barrel with strong wind power. The lottery balls are intensely mixed for adequate randomness and fairness as expected from a lottery-drawing process. However, the foregoing configuration has some shortcomings.

1. The number of lottery balls mixed in the mixing barrel is usually large. With the high intensity of mixing operation, the lottery-drawing spectators, who may usually be the lottery bettors, are unlikely to clearly witness whether the lottery balls associated with his/her interests have the odds to be drawn. What he/she can do throughout the drawing process is waiting until the lottery balls are drawn and displayed, making the spectators and/or related bettors feel less relevant. Therefore, there is a need for making the drawing process more relevant and more interesting to the spectators and/or related bettors; and

2. When the blower mixes the lottery balls with strong wind, the balls tend to impact the mixing barrel or other balls heavily. Such impact is undesired as it not only causes huge noise, but also damages the lottery balls.

Hence, the inventor of the present invention has paid efforts to improve the existing lottery-drawing machines with the attempt to allow the spectators and/or related bettors to enjoy more excitement and more enjoyment during a lottery ball-drawing process.

### SUMMARY OF THE PRESENT INVENTION

For addressing the shortcomings of the prior art, the present invention provides a circular-track ball-drawing device.

The objective of the present invention is to provide the circular-track ball-drawing device that comprises a circular ball-delivering mechanism and a transmission assembly. The circular ball-delivering mechanism has a helm-like wheel. The helm-like wheel is peripherally provided with a plurality of blades. The helm-like wheel is coupled to the transmission assembly so that it can roll. The blades serve to take, transport and discharge lottery balls in, along and out of the circular ball-delivering mechanism. The circular ball-delivering mechanism includes transparent upper and lower semicircular housings that house the helm-like wheel and make the path of the lottery balls visible from outside. Thereby, a related bettor is allowed to watch the ball-drawing process with more excitement and more enjoyment.

Another objective of the present invention is to provide the circular-track ball-drawing device that implements the motor of the transmission assembly to intermittently drive the circular ball-delivering mechanism, so the lottery balls are less impacted. This is helpful to not only reduce noise, but also prevent the lottery balls from being damaged.

### BRIEF DESCRIPTION OF THE DRAWINGS

FIG. 1 is an exploded view of a circular-track ball-drawing device according to the present invention.

FIG. 2 is a perspective view of the circular-track ball-drawing device.

FIG. 3 is a cross-sectional view of the circular-track ball-drawing device.

FIG. 4 illustrates a scene where balls are fed into the circular-track ball-drawing device.

FIG. 5 illustrates a scene where the circular-track ball-drawing device discharges some of the balls.

FIG. 6 shows a helm-like wheel of the circular-track ball-drawing device additionally equipped with some filling members.

FIG. 7 is a cross-sectional view of the circular-track ball-drawing device with the filling members installed.

### DETAILED DESCRIPTION OF THE PREFERRED EMBODIMENT

The invention as well as a preferred mode of use, further objectives and advantages thereof will be best understood by reference to the following detailed description of illustrative embodiments when read in conjunction with the accompanying drawings.

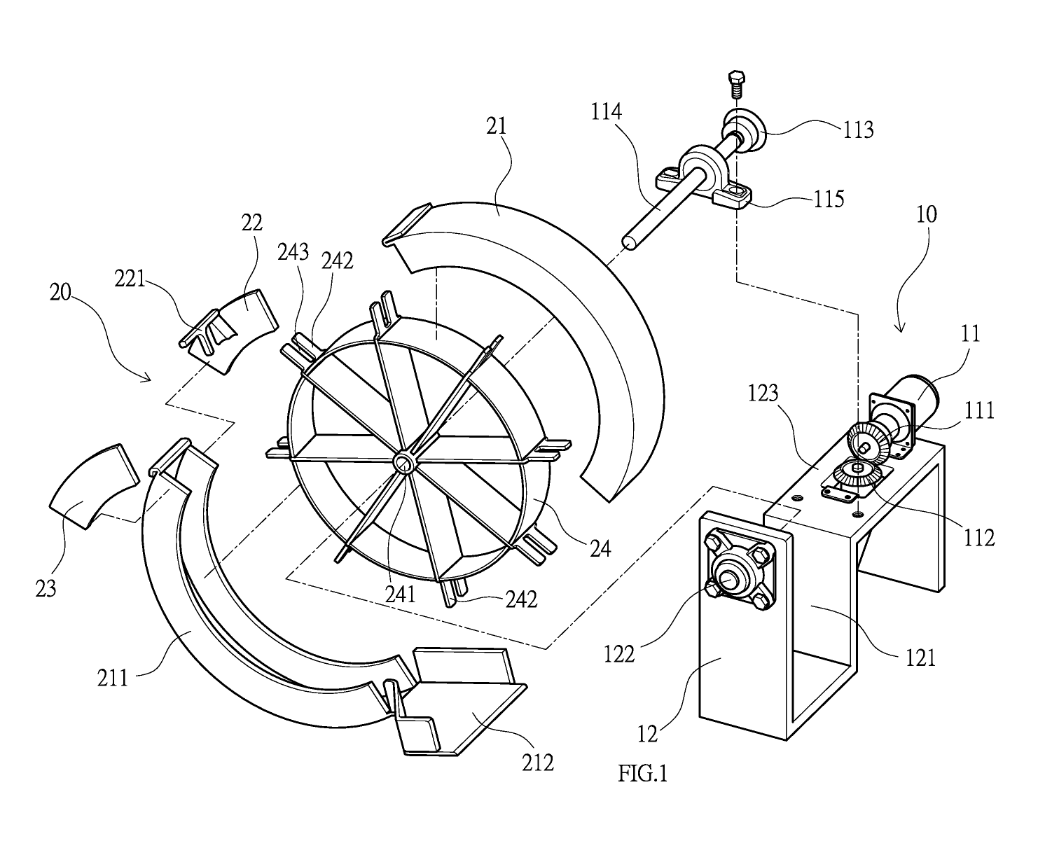

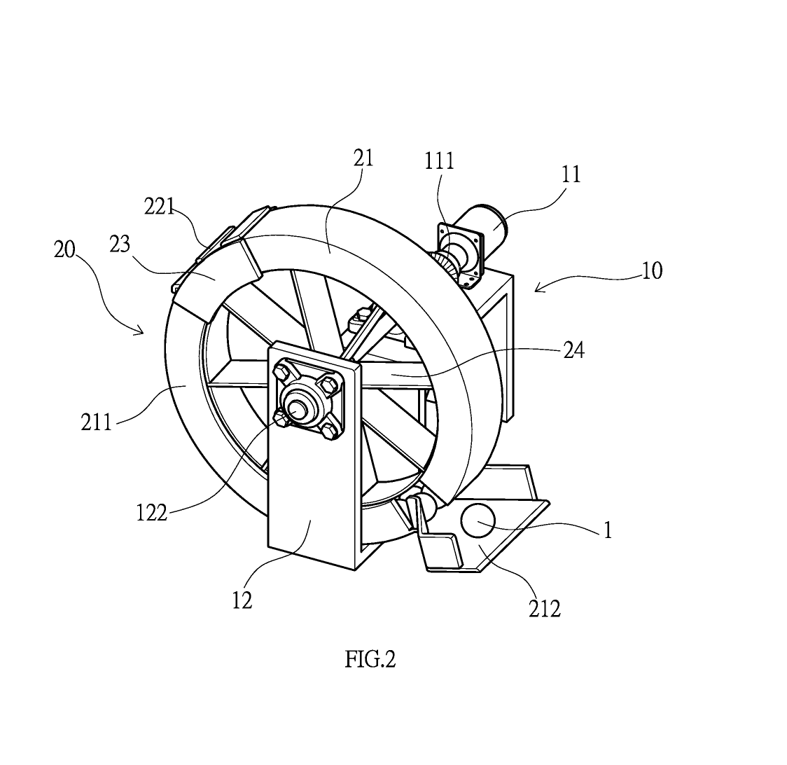

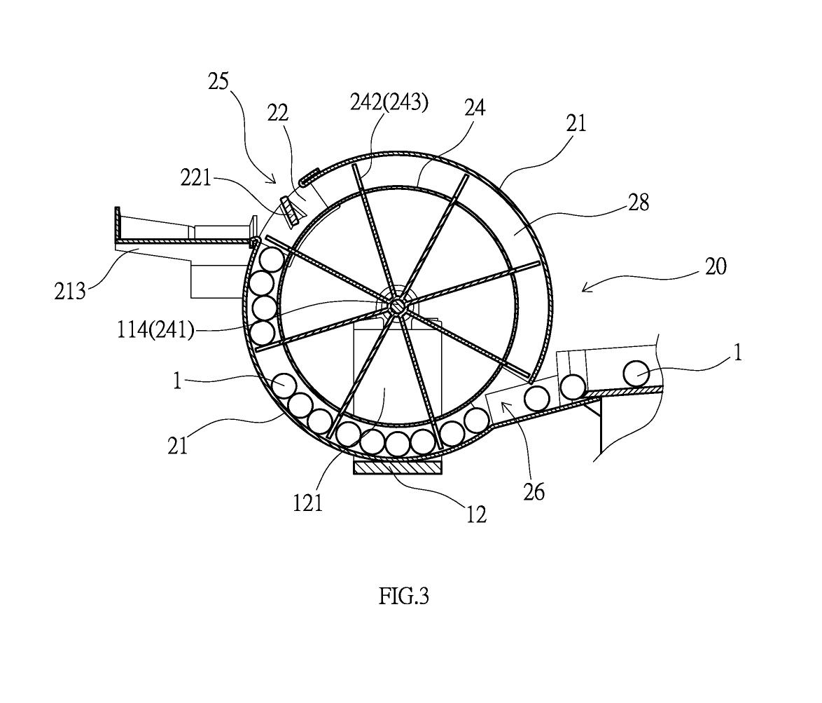

Referring to FIGS. 1 through 3, a circular-track ball-drawing device as disclosed comprises a circular ball-delivering mechanism 20 and a transmission assembly 10. The circular ball-delivering mechanism 20 is housed by an upper semicircular housing 21 and a lower semicircular housing 211 that are such joined at an upper joint by two curved joining pieces 22, 23 that an upper opening 25 is formed. A T-shaped ball-retaining bar 221 spans across the two curved joining pieces 22, 23 in a predetermined angle. At a lower joint between the upper and lower semicircular housings 21, 211, a ball-feeding platform 212 is attached to the lower semicircular housing 211 so as to form a lower opening 26. The combination of the upper and lower semicircular housings 21, 211 is then mounted on a support 12 and rotatably received in a receiving portion 121. The upper and lower semicircular housings 21, 211 jointly shell a helm-like wheel 24, without contacting it. The helm-like wheel 24 is provided centrally with an axial hole 241, and is provided peripherally with a plurality of blades 242 each having a passing slot 243. The passing slot 243 is such configured that the ball-retaining bar 221 can pass therethrough without hitting the blade 242. Between the blades 242 of the helm-like wheel 24 and the upper and lower semicircular housings 21, 211, a ball-circulating track 28 is defined. The transmission assembly 10 includes the support 12 that has the U-shaped receiving portion 121 constructed from a multi-turn board. The receiving portion 121 receives the circular ball-delivering mechanism 20. The support 12 has its front surface equipped with a shaft seat 122, and has its rear part formed with a level shelf 123, on which a motor 11 and a driving shaft 114 are installed. The driving shaft 114 is fitted in the axial hole 241 of the helm-like wheel 24 and the shaft seat 122, and is positioned with respect to the shelf 123 by a holder 115. A first bevel gear 111 is provided on the motor 11, and a second bevel gear 112 in installed on the shelf 123, while a third bevel gear 113 is attracted to the driving shaft 114 from back. The second bevel gear 112 engages with the first bevel gear 111 and the third bevel gear 113, respectively. Thereby, the first bevel gear 111 drives the second bevel gear 112, and the second bevel gear 112 then drives the third bevel gear 113, so as to rotate the driving shaft 114 that in turn drives the helm-like wheel 24 to roll.

With the aforementioned configuration, plural lottery balls 1 may be taken into the ball-circulating track 28 through the lower opening 26 and circulate in the circular ball-circulating track 28. One said lottery ball 1 may later get gripped and launched out the upper opening 25 by the blade 242 and the ball-retaining bar 221, as being drawn.

The components used in the present invention are to be described in detail below. Please refer to FIG. 1 through FIG. 3, the upper semicircular housing 21 and the lower semicircular housing 211 that has the ball-feeding platform 212 are both made of a transparent plastic material, so can be seen through from outside. The upper and lower semicircular housings 21, 211 are joined by the curved joining pieces 22, 23 into a circular case, and the upper and lower openings 25, 26 are formed at the joints therebetween. The combination of the upper and lower semicircular housings 21, 211 is then fixed to the support 12 and received in the receiving portion 121 in a non-rotatable manner. The blades 242 are sandwiched by the upper and lower semicircular housings 21, 211 so as to form several closed rooms where the lottery balls 1 are carried by the blade 242 without coming off.

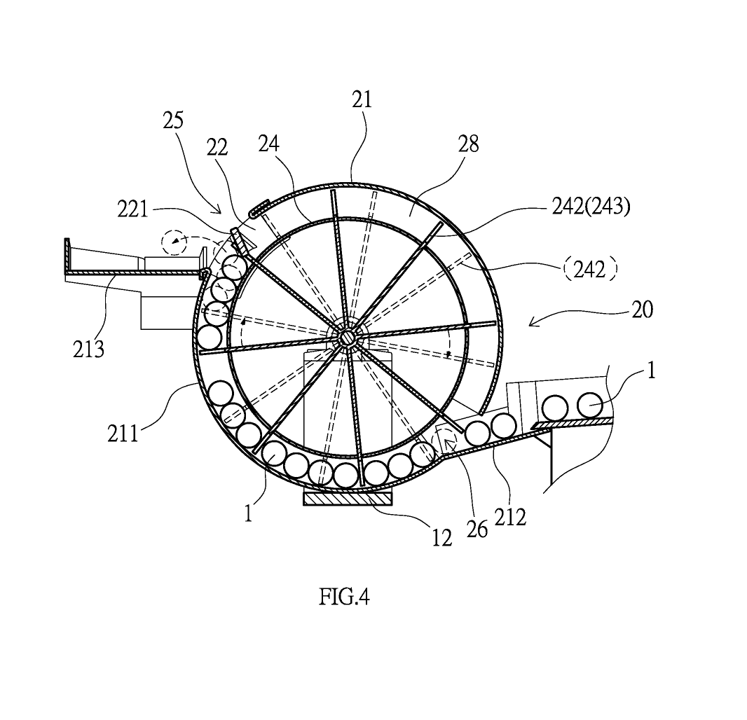

Referring to FIG. 4, when plural lottery balls 1 are placed on the ball-feeding platform 212, the tilted ball-feeding platform 212 makes the lottery balls 1 to roll toward the lower opening 26. Since the ball-feeding platform 212 is tapered toward the lower opening 26 and the lower opening 26 allows only one lottery ball 1 to pass a time, the lottery balls 1 jostle forward while having their locations and order randomly changed, and then enter the ball-circulating track 28 as the helm-like wheel 24 rolls. The passing slot 243 of the blade 242 has a width smaller than a diameter of the lottery ball 1, so the lottery balls 1 are pushed forward along the ball-circulating track 28 by the blades 242. During the foregoing process, a bettor can watch the lottery balls 1 to see whether the one(s) of his/her interests has (have) the odds to be drawn first. The blades 242 divide the ball-circulating track 28 into several rooms where the lottery balls 1 of various numbers may be transported depending on the ball-feeding rate at the ball-feeding platform 212.

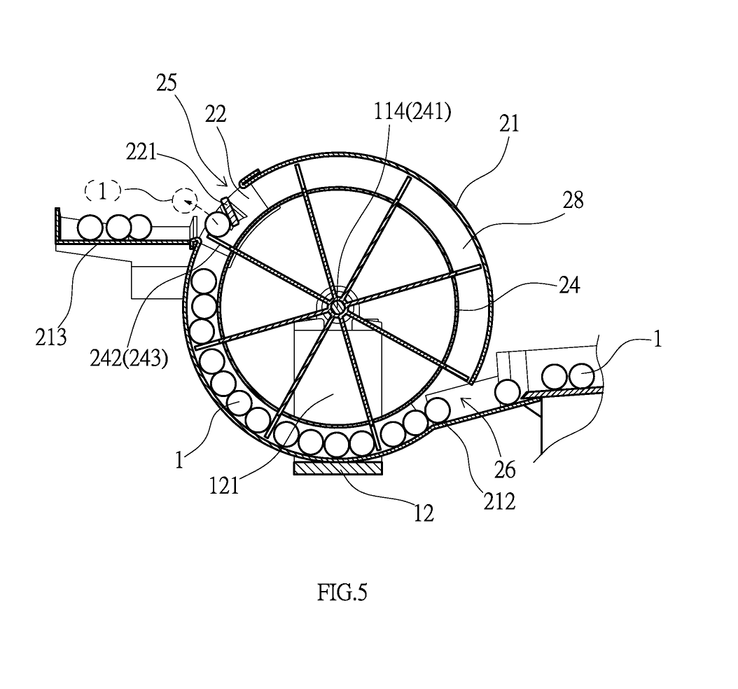

Referring to FIG. 5, when the lottery balls 1 arrive at the upper opening 25, the T-shaped ball-retaining bar 221 spans across the curved joining pieces 22, 23 and has its straight rod extending into the in a predetermined angle ball-circulating track 28, so that the lottery ball 1 can be retained by the T-shaped ball-retaining bar 221. Each of the ball-retaining bar 221 and the blades 242 is made of metal or rigid plastic and formed with smooth surfaces. Since the blade 242 of the helm-like wheel 24 and the ball-retaining bar 221 include an outward opening angle, the moving blade 242 and the ball-retaining bar 221 can jointly grasp the smooth lottery ball 1 and force the lottery ball 1 to jump out to the ball-present platform 213 through the upper opening 25.

It is to be noted that for the helm-like wheel 24 to roll, the motor 11 drives the first bevel gear 111 to rotate the second bevel gear 112 and the third bevel gear 113 successively, thereby using the driving shaft 114 to rotate the helm-like wheel 24. Since the lottery balls 1 are transported throughout the process without impacting each other, noise appearing can be reduced.

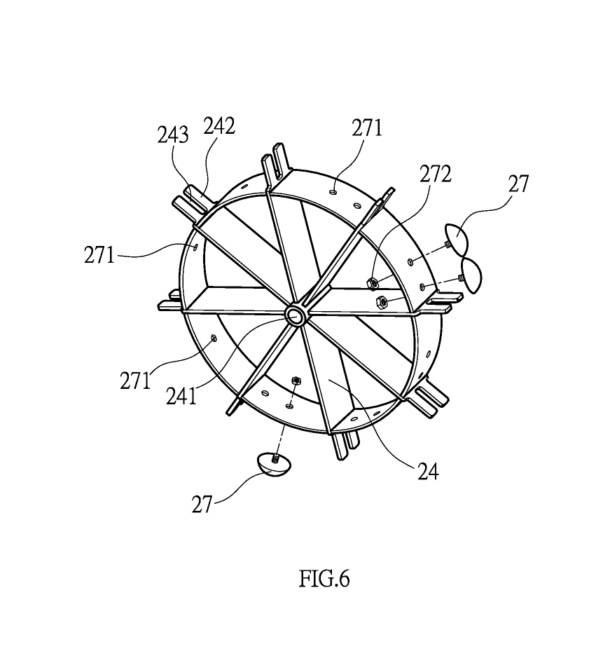

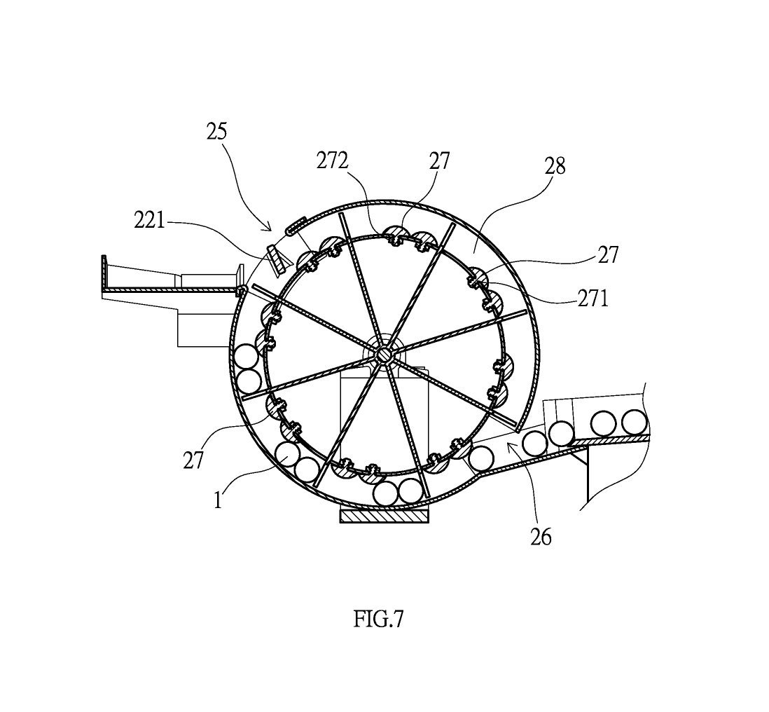

In another embodiment of the present invention, the helm-like wheel 24 may be further provided peripherally with a plurality of through holes 271 as shown in FIG. 6 and FIG. 7. Each of the through holes 271 allows a filling member 27 to pass therethrough and combine with a nut 272. When the helm-like wheel 24 rolls, these filling members 27 are free from being retained by the ball-retaining bar 221. This allows adjustment of the number of the lottery balls 1 in the ball-circulating track 28, thereby making it possible to change how many and how fast the lottery balls 1 to be drawn. The present invention has been described with reference to the preferred embodiments and it is understood that the embodiments are not intended to limit the scope of the present invention.

Moreover, as the contents disclosed herein should be readily understood and can be implemented by a person skilled in the art, all equivalent changes or modifications which do not depart from the concept of the present invention should be encompassed by the appended claims.

What is claimed is:

1. A circular-track ball-drawing device, comprising:
a circular ball-delivering mechanism, being housed by an upper semicircular housing and a lower semicircular housing, which are such joined at an upper joint by two curved joining pieces that an upper opening is formed, a T-shaped ball-retaining bar spanning across the two curved joining pieces in a predetermined angle; at a lower joint between the upper and lower semicircular housings, a ball-feeding platform being attached to the lower semicircular housing so as to form a lower opening; the upper and lower semicircular housings such assembled being assembled to a transmission assembly; the upper and lower semicircular housings jointly shelling but not contacting a helm-like wheel; the helm-like wheel being provided centrally with an axial hole and being provided peripherally with a plurality of blades each having a passing slot, the passing slot allowing the ball-retaining bar to pass freely therethrough; and between the blades of the helm-like wheel and the upper and lower semicircular housings a ball-circulating track being defined; and
the transmission assembly having a support that provides a receiving portion for receiving the circular ball-delivering mechanism; the support having a rear part formed with a level shelf for a motor and a driving shaft to be mounted thereon; the driving shaft such passing through the axial hole of the helm-like wheel that when rotated by the motor, wherein the driving shaft drives the helm-like wheel to roll;
whereby, plural lottery balls are taken into the ball-circulating track through the lower opening, and one said lottery ball arrives at the upper opening is grasped and launched out the upper opening by the corresponding blade and the ball-retaining bar.

2. The circular-track ball-drawing device of claim 1, wherein a first bevel gear is provided at the motor and a second bevel gear is provided at the shelf, while a third bevel gear is provided at one end of the driving shaft, in which the second bevel gear engages with the first bevel gear and the third bevel gear, respectively, whereby the first bevel gear drives the second bevel gear, and the second bevel gear then drives the third bevel gear, so as to rotate the driving shaft that in turn drives the helm-like wheel to roll.

3. The circular-track ball-drawing device of claim 1, wherein the support has a shaft seat provided at a front surface thereof and the driving shaft is rotatably assembled to the support at the shaft seat.

4. The circular-track ball-drawing device of claim 1, wherein the receiving portion is defined by a multi-turn board of the support.

5. The circular-track ball-drawing device of claim 1, wherein the upper semicircular housing and the lower semicircular housing are both made of transparent plastic.

6. The circular-track ball-drawing device of claim 1, wherein the ball-retaining bar and the blades are made of metal or rigid plastic and formed with smooth surfaces.

7. The circular-track ball-drawing device of claim 1, wherein the passing slot of the blade has a width smaller than a diameter of the lottery ball.

8. The circular-track ball-drawing device of claim 1, wherein the helm-like wheel is peripherally provided with a plurality of through holes and a plurality of filling members are attached to the helm-like wheel by each passing through a said through hole and combining with a nut.
